(19) United States
(12) Patent Application Publication
(10) Pub. No.: US 2025/0007031 A1
(43) Pub. Date: Jan. 2, 2025

(54) ULTRA HIGH-PERFORMANCE BATTERY MODULE WITH ACTIVE AND DYNAMIC MANAGEMENT OF OPERATING TEMPERATURE AND PRESSURE

(71) Applicant: HYDRO-QUÉBEC, Montréal (CA)

(72) Inventor: Serge MONTAMBAULT, Saint-Marc-sur-Richelieu (CA)

(73) Assignee: HYDRO-QUÉBEC, Montréal, QC (CA)

(21) Appl. No.: 18/708,877

(22) PCT Filed: Oct. 19, 2022
(86) PCT No.: PCT/CA2022/051538

§ 371 Date: May 9, 2024

(30) Foreign Application Priority Data
Nov. 10, 2021 (CA) 3139110

(51) Int. Cl. H01M 10/633; H01M 10/42; H01M 10/48; H01M 10/613; H01M 10/615; H01M 10/643; H01M 10/6568; H01M 50/213; H01M 50/287; H01M 50/618; H01M 50/691

(52) U.S. Cl. CPC H01M 10/633; H01M 10/4257; H01M 10/486; H01M 10/613; H01M 10/615; H01M 10/643; H01M 10/6568; H01M 50/213; H01M 50/287; H01M 50/618; H01M 50/691; H01M 2010/4271

(57) ABSTRACT

A system and a method for managing operating temperature and pressure of a battery are disclosed. Cells of the battery are housed in cylindrical modules into which a heat transfer fluid under pressure and at a temperature circulates. A fluidic unit has a return reservoir that collects oil leaving the modules, and cooling and heating reservoirs containing oil pumped from the return reservoir at predefined hot and cold temperatures. Oil is transmitted to the modules at a temperature and a pressure almost instantaneously obtained by regulated mixing and flow rate of hot and cold oil. The mixing and the flow rate are controlled by controllers connected to a BMS which manages oil pressure and temperature setpoints to be applied to the cells as a function of a demand in power and in energy received by the BMS and pressure and temperature measurements taken by sensors in the system.

### FIELD OF THE INVENTION

The invention relates to a system and a method for actively and dynamically managing operating pressure and temperature of cells of one or more battery modules.

### CONTEXT

Operating pressure and temperature values of Li-ion cells cannot be used as references for optimal operation of next generation battery cells, including a solid-state battery. According to current knowledge, a precise, active and dynamic management of the operating pressure and temperature values of batteries may be critical to:
minimize/eliminate the appearance of dynamic porosities or “voids” during rapid discharge (“stripping” phase), which subsequently promote the formation of dendrites during rapid charging;
increase the charging speed while limiting/eliminating the process of formation and propagation of dendrites during the “plating”;
increase the battery life (maintaining the capacity, minimizing “dead” or inactive lithium);
limit the rate of increase of the impedance of the battery cells over the cycles;
work-harden zones/tips of dendrites (increase of the diffusion/transport of lithium or other metal forming the anode);
guarantee that the quality of the contacts at the cathode-electrolyte-anode interfaces of the cells is maintained;
minimize/eliminate damage caused to the cells in case of extraordinary demand;
fully use the potential of the next generation batteries.

Known in the art, WO application 2019/017994 (Hettrich) proposes an active and passive battery pressure management and a battery module in which a fluid maintains an isostatic pressure on at least one electrochemical cell in the module.

US application 2020/0259232 (Ge et al.) proposes a stable battery with high performance on demand, in which a battery cell comprises a heating element such as a resistor to raise the temperature of the battery and improve its performances.

US application 2016/0380315 (Weicker et al.) proposes battery systems having independently controlled sets of battery cells, based on specialized and complementary battery modules, for example a power-specialized module and an energy-specialized module. The specificity of the modules may be related to the use of different chemistries from one module to another.

US application 2014/0227568 (Hermann) proposes battery systems with selective thermal management including battery modules working together so that one module heats the other as needed.

US application 2013/0330577 (Kristofek et al.) proposes a dynamic pressure control in a battery assembly by means of a fluid which may also be used to manage the temperature. The fluid is not in direct contact with the battery cells but rather contained in pouches which are in contact with the cells and allow to cool them and to apply a pressure on these cells.

US application 2021/0167414 (Torres Martinez) proposes a pressurized electrochemical battery and a corresponding manufacturing process. A system for dynamic management of the pressure and of the temperature is achieved by means of a fluid playing both roles, in a manner similar to what is proposed in US application 2013/0330577.

DE application 102019211729 (Jahnke et al.) proposes a vehicle battery module comprising a dynamic pressure management system. Mechanisms applying a pressure on cells of a battery may be passive or active by means of springs, piezoelectrics or small fluid-filled pouches.

DE application 102018203050 (Hoffmann) proposes a dynamic pressure management system for a battery based on a fluid injected into pouches applied against cells of the battery.

None of the systems proposed in the art is capable of actively and dynamically managing important pressure and temperature variations at the level of cells of a battery with an almost instantaneous response time as a function of given operating or demand conditions, in order to exploit the possible performance features of such a battery.

### SUMMARY

An object of the present invention is to provide a system for managing operating pressure and temperature of cells of one or more battery modules, which allows to exploit the possible performance features of such a battery.

According to one aspect of the present invention, there is provided a system for managing operating pressure and temperature of a battery, the system comprising:
at least one battery module having a chamber housing cells of the battery, and at least one on-board circuit connected to the cells and configured to control their operation and monitor their state of charge, the chamber having opposite fluidic inlet and outlet for receiving and discharging a heat transfer fluid applied to all the cells;
a fluidic unit having a return reservoir in communication with the fluidic outlet of each battery module, a cooling reservoir for containing a quantity of the heat transfer fluid pumped from the return reservoir at a predefined cold temperature, a heating reservoir for containing a quantity of the heat transfer fluid pumped from the return reservoir at a predefined hot temperature, and a temperature and pressure regulating device having inlets in communication with the cooling and heating reservoirs and at least one outlet in communication with the fluidic inlet of each battery module in order to transmit the heat transfer fluid at a temperature and a pressure by controlled mixing and flow rate of the heat transfer fluid derived from the cooling and heating reservoirs;
temperature and pressure sensors for measuring temperature and pressure of the heat transfer fluid circulating between the fluidic unit and said at least one battery module;
at least one controller having inputs for receiving temperature and pressure setpoint signals for the heat transfer fluid in said at least one battery module, inputs for receiving temperature and pressure measurement signals produced by the temperature and pressure sensors, and outputs for producing signals controlling the mixing and the flow rate of the heat transfer fluid transmitted by the fluidic unit according to the setpoint signals and the temperature and pressure measurement signals; and
a BMS connected to said at least one controller and to said at least one on-board circuit, the BMS being configured to produce the temperature and pressure setpoint signals for the heat transfer fluid and a demand setpoint intended for said at least one battery module as a function of a demand in energy and in power received in input and the state of charge provided by said at least one on-board circuit.

According to another aspect of the invention, there is provided a method for managing operating pressure and temperature of a battery, the method comprising the steps of:
housing cells of the battery in a chamber defined by at least one battery module, the chamber having opposite fluidic inlet and outlet for receiving and discharging a heat transfer fluid applied to all the cells;
monitoring a state of charge of the cells in said at least one battery module;
collecting the heat transfer fluid discharged by the fluidic outlet of each battery module into a return reservoir;
separately cooling and heating quantities of the heat transfer fluid pumped from the return reservoir into the cooling and heating reservoirs at predefined cold and hot temperatures;
conveying the heat transfer fluid to the fluidic inlet of said at least one battery module at temperature and pressure regulated by mixing and flow rate control of the heat transfer fluid derived from the cooling and heating reservoirs;
taking temperature and pressure measurements of the heat transfer fluid conveyed towards and discharged by said at least one battery module;
controlling the mixing and the flow rate of the heat transfer fluid conveyed to said at least one battery module according to the measurements and temperature and pressure setpoints; and
adjusting the temperature and pressure setpoints of the heat transfer fluid and a demand setpoint intended for said at least one battery module as a function of a demand in energy and in power and the state of charge of the cells in said at least one battery module.

Without limiting, the present invention provides a system for managing operating pressure and temperature of cells of one or more battery modules, allowing at the same time or separately: to reach a precise pressure value applied to the cells as a function of demand conditions of the battery; to apply a uniform pressure on the battery cells; to apply important pressure values, for example up to 2 000 psi; to very rapidly vary a pressure value applied to the cells as a function of changes in demand or operating conditions of the battery; a volume variation of the cells in charging and discharging cycle; to reach a precise temperature value of the cells as a function of demand or operating conditions of the battery; to very rapidly vary a temperature value of the cells as a function of changes in demand or operating conditions; to apply important temperature values and variations, for example from 0 to 80° C.; to obtain a uniform temperature on each of the cells, over their entire surface; to adjust pressure and temperature control strategies as a function of a state of health of the battery and specificities related to a use of the battery by means of various and/or scalable algorithms; in the case where the battery is used in a vehicle, to minimize a transfer of vibrations of the vehicle to the battery cells in order to preserve integrity of the electrical contacts; to minimize energy consumption dedicated to cooling or heating a heat transfer fluid and for applying an important pressure; to integrate in a cost-effective way the different assemblies of the system in a vehicle body; and to neutralize chemical reactions in case of defective cells or an accident.

### BRIEF DESCRIPTION OF THE DRAWINGS

A detailed description of preferred embodiments will be given herein below with reference to the following drawings:

FIG. 1 is a schematic diagram illustrating a system for managing operating pressure and temperature of a battery according to an embodiment of the invention.

FIG. 2 is a schematic diagram illustrating a pressure and temperature control arrangement according to an embodiment of the invention.

FIG. 3 is a flowchart illustrating a command and control process of the system according to an embodiment of the invention.

FIG. 4 is a flowchart illustrating parameters for pressure and temperature management and operation of a battery module according to an embodiment of the invention.

FIGS. 5A, 5B, 5C and 5D are graphs illustrating examples of protocols for managing pressure and temperature implemented in the system according to an embodiment of the invention.

FIG. 6 is an exploded schematic diagram of a battery module with button type cells according to an embodiment of the invention.

FIGS. 7A and 7B are perspective partial views of an internal structure of a battery module according to an embodiment of the invention.

FIGS. 8A, 8B, 8C and 8D are schematic diagrams of possible arrangements of several battery modules according to an embodiment of the invention.

FIGS. 9A and 9B are exploded schematic diagrams of a battery module with prismatic type cells according to an embodiment of the invention.

### DETAILED DESCRIPTION OF THE PREFERRED EMBODIMENTS

In the context of this disclosure, a battery is formed of cells which are made of two electrodes—a positive terminal (or cathode) and a negative terminal (or anode)—separated by a medium acting as ionic conductor, called electrolyte. The cells may be of different architectures, formats and dimensions. The anodes, cathodes and electrolytes may be made of different materials. The electrolyte may be liquid, solid, hybrid (polymer, ceramic, liquid, etc.).

As used in the context of this disclosure, the expression “almost instantaneous” or “instantaneous” means a lapse of time or a response time of around 15 s or less, unless the context requires otherwise.

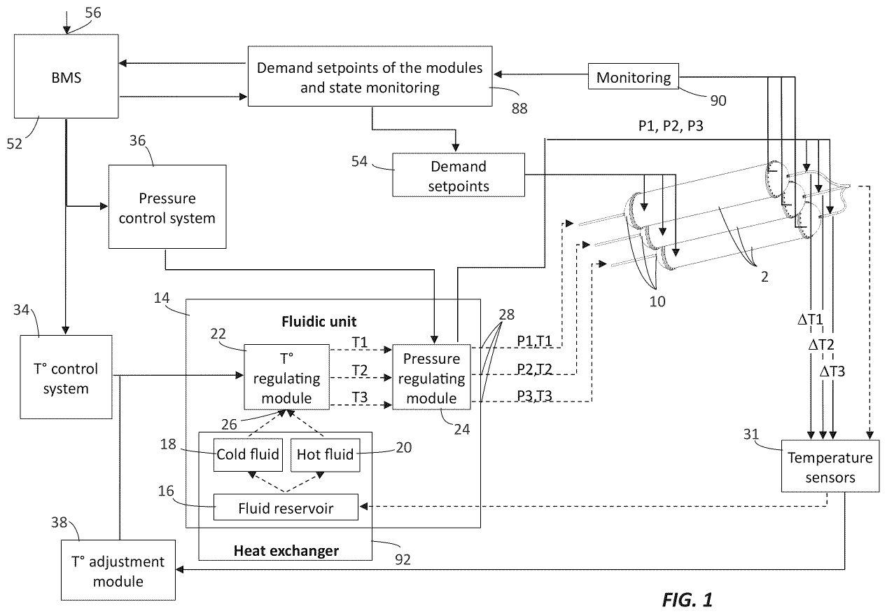

Referring to FIG. 1, a system for managing operating pressure and temperature of a battery according to an embodiment of the invention is illustrated. The system comprises at least one battery module 2. In the illustrated case and for the following disclosure, reference to a system comprising three battery modules 2 will be made for simplification purposes only. It should be understood that the number of battery modules in the system may different from one or three, for example two or more than three if desired. The invention provides a solution to the problem of optimally using a battery by managing operating pressures and temperatures of the cells it contains in an active, dynamic, precise and almost instantaneous manner by means of a heat transfer fluid circulating in the system according to control modes which will be described hereinafter. In FIG. 1, the dotted lines represent circulation lines of the heat transfer fluid while the solid lines represent signal communication lines.

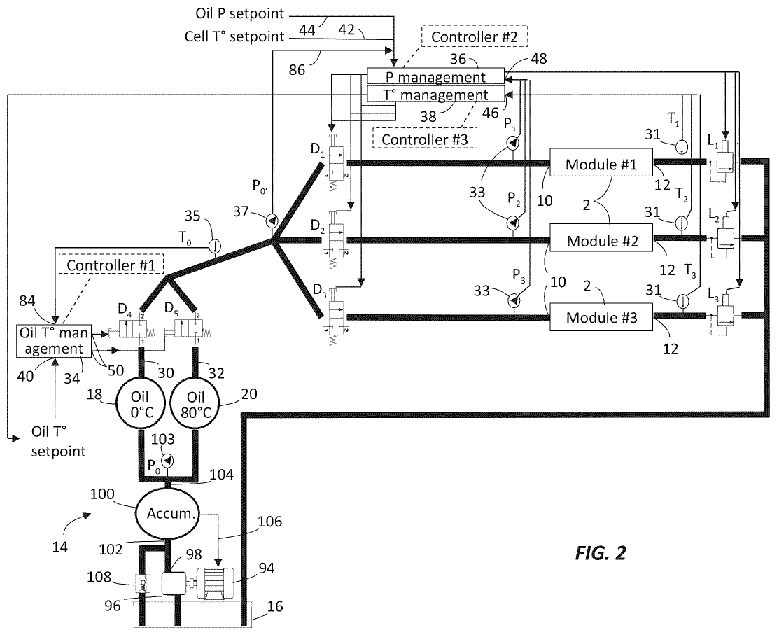

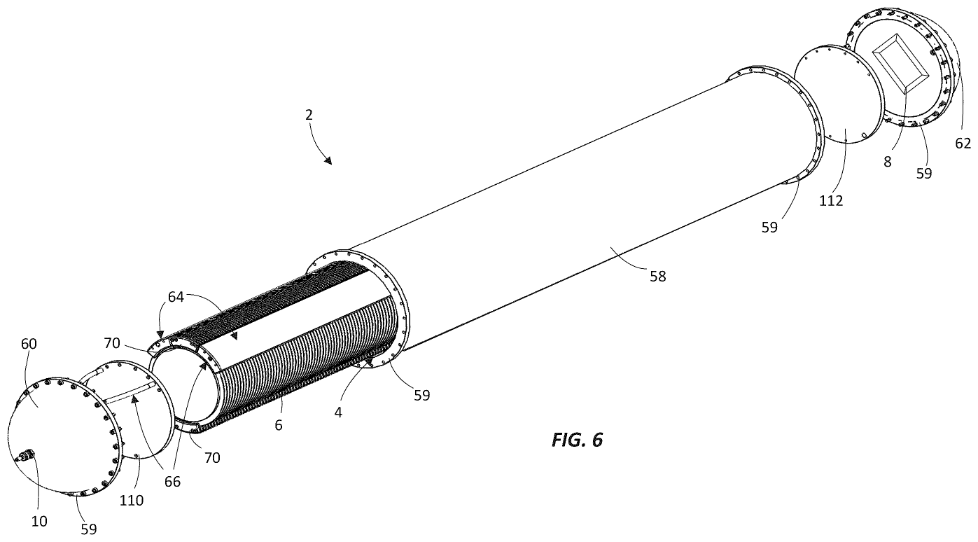

Referring to FIG. 6, each battery module 2 has a chamber 4 housing cells 6 of the battery, and at least one on-board circuit 8 connected to the cells 6 and configured to control their operation and monitor their state of charge. The on-board circuit(s) 8 may include power units, energy sinks, current limiters and a smart charger (not shown), allowing to generate the relevant conditions of pressure, temperature and current density to obtain the optimal performances from the battery modules 2. The chamber 4 has opposite fluidic inlet and outlet 10, 12 (shown e.g. in FIG. 2) for receiving and discharging a heat transfer fluid applied to all the cells 6. Preferably, the heat transfer fluid is a liquid, advantageously oil, and more advantageously mineral oil allowing neutralization of potential chemical reactions in the event of a defective or damaged cell. In the following disclosure, the term “hydraulic” may be used instead of “fluidic” in respect with oil used as heat transfer fluid, without limiting the heat transfer fluid to oil and pressure and temperature regulating devices for oil only.

Referring again to FIG. 1, the system comprises a fluidic unit 14 having a return reservoir 16 in communication with the fluidic outlet 12 (shown e.g. in FIG. 2) of each battery module 2, a cooling reservoir 18 for containing a quantity of the heat transfer fluid pumped from the return reservoir 16 at a predefined cold temperature, a heating reservoir 20 for containing a quantity of the heat transfer fluid pumped from the return reservoir 16 at a predefined hot temperature, and a temperature and pressure regulating device 22, 24 having inlets 26 in communication with the cooling and heating reservoirs 18, 20 and at least one outlet 28 in communication with the fluidic inlet 10 of each battery module 2 in order to transmit the heat transfer fluid at a desired temperature and pressure by controlled mixing and flow rate of the heat transfer fluid derived from the cooling and heating reservoirs 18, 20. According to an embodiment, the predefined hot temperature is 100° C. while the predefined cold temperature is −30° C., so that the heat transfer fluid supplied to the battery modules 2 by the fluidic unit 14 may have a temperature varying almost instantaneously from −30° C. to 100° C. for their dynamic management. Other cold and hot temperature values may be appropriate depending on the chemistries of the battery modules 2 used and their operating temperature ranges, for example and preferably at most 0° C. and 80° C.

Referring to FIG. 2, the system comprises temperature sensors 31 (T₁, T₂, T₃) and pressure sensors 33 (P₁, P₂, P₃) for sensing the temperature and the pressure of the heat transfer fluid circulating between the fluidic unit 14 and the battery modules 2. According to an embodiment of the invention, the system comprises controllers 34, 36, 38 (hereinafter also referred to as controllers #1, #2, #3) having inputs 40, 42, 44 for receiving temperature and pressure setpoint signals for the heat transfer fluid in the battery modules 2, inputs 46, 48 for receiving temperature measurement signals T₁, T₂, T₃ and pressure measurement signals P₁, P₂, P₃ produced by the temperature sensors 31 and the pressure sensors 33, outputs 50 for producing signals controlling the mixing and the flow rate of the heat transfer fluid transmitted by the fluidic unit 14 according to the setpoint signals and the temperature and pressure measurement signals. The functions of the controllers 34, 36, 38 may be performed by a single controller if desired. Other types of sensors allowing to monitor, measure, inform, regulate, adjust, and evolve may be added in the system, for example sensors for measuring current, measuring voltage, analyzing gas dissolved in oil or other heat transfer fluid used (not shown).

Referring again to FIG. 1, the system comprises a BMS 52 connected to the controllers 34, 36, 38 (shown e.g. in FIG. 2) and to the on-board circuits 8 (shown e.g. in FIG. 6) of the battery modules 2. The BMS 52 is configured to produce the temperature and pressure setpoint signals for the heat transfer fluid and one or more demand setpoints 54 intended for the battery modules 2 as a function of a demand in energy and in power received in input 56 and the state of charge provided by the on-board circuits 8.

The BMS 52 may be configured to store and execute algorithms for controlling operating parameters of the battery modules 2 as a function of conditions of demand, the state of charge and a state of health of the battery modules 2, and as a function of an ambient temperature and a preestablished vocation of a battery module among the battery modules 2. The conditions of demand, state of charge and state of health may be transmitted to the BMS 52 via a controller 88 controlling demand setpoints of the battery modules and the states of charge and of health provided by a monitoring module 90 processing the signals produced by the on-board circuits 8 (shown e.g. in FIG. 6) of the battery modules 2. The preestablished vocation of a battery module 2 may be programmed in the BMS 52 so that the BMS 52 generates the appropriate command and control signals to dynamically and actively manage its pressure, its temperature, its demand usage and its states depending on its vocation via the controller 88 and the circuit 54 in communication with the on-board circuits 8 of the battery modules 2, as well as via the pressure-control controller 36 and the temperature-control controllers 34, 38. The vocation of a battery module 2 may, for example, consist in making it operate in a different way than that for which its cells 6 have been normally designed. The operating parameters include the pressure and the temperature of the heat transfer fluid circulating in the battery modules 2, and may also include a power allowed by each battery module 2. The demand conditions may be, for example, a fast charging, a power demand, for example an acceleration, a load towing, a sudden braking in the case of an electric vehicle.

The system may be equipped with a heat exchanger 92 for heat exchange with the reservoirs 16, 18, 20 of the fluidic unit 14 and peripheral devices (not shown) generating a thermal energy, such as a heating device, an air conditioner, a brake motor, a smart charger, for minimization of the energy consumption to heat/cool the heat transfer fluid.

Referring again to FIG. 2, according to an embodiment, the fluidic unit 14 is provided with a pump 94 and an accumulator 100 allowing to dynamically adjust and manage the pressure to be applied to the battery modules 2 to a desired value. The pump 94 has an inlet 96 communicating with the return reservoir 16 and an outlet 98 for transmitting a quantity of the heat transfer fluid pumped from the return reservoir 16. The accumulator 100 has an inlet 102 communicating with the outlet 98 of the pump 94 and an outlet 104 communicating with the cooling and heating reservoirs 18, 20. The accumulator 100 produces a control signal 106 controlling the pump 94 according to a pressure measurement provided by a pressure sensor 103 (P0) at the outlet 104 of the accumulator 100 so that a pressure of the heat transfer fluid in the cooling and heating reservoirs 18, 20 is slightly higher than the pressure setpoint 44. A pressure relief valve 108 is preferably added in parallel to the pump 94.

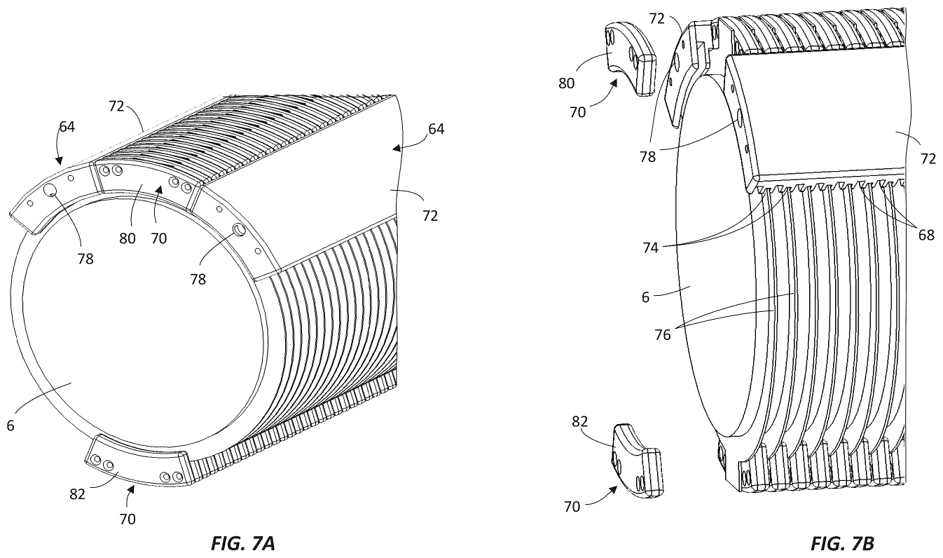

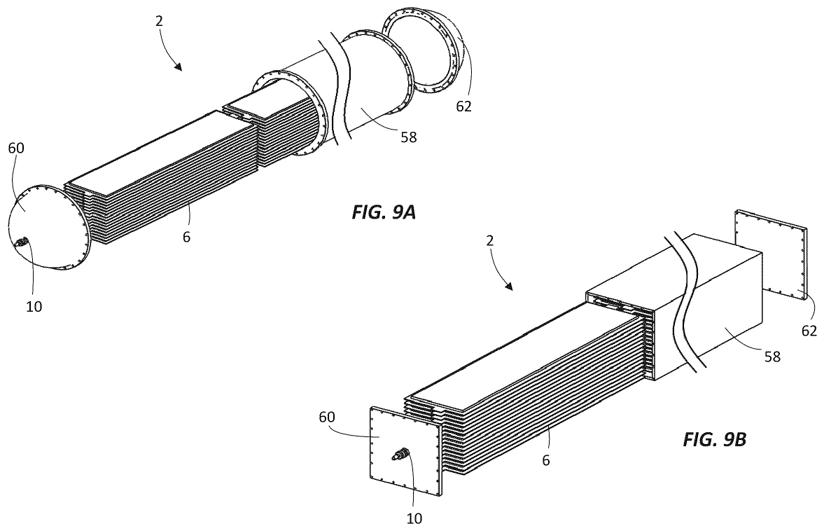

Referring again to FIG. 6, each battery module 2 may be formed of a tubular element 58 and end elements 60, 62 closing the tubular element 58 to define the chamber 4 which is like a reservoir. A structure 64 for supporting and spacing the cells 6 in an axial direction of the tubular element 58 may advantageously ensure an appropriate spacing of the cells 6 to allow their volume variation during charge-discharge cycles and to minimize a transmission of mechanical vibrations to the cells 6 immersed in the heat transfer fluid. A distributor arrangement 66 of the heat transfer fluid is in communication with the fluidic inlet 10 and has openings 68 (shown e.g. in FIG. 7B) aligned with spaces between the cells 6. An arrangement 70 of electrical connections connects the cells 6 and the on-board circuit(s) 8 together. The tubular element 58 may have a cylindrical shape as shown in FIG. 6, which is particularly well suited for button type cells 6 as also shown in the Figure. The end elements 60, 62 may advantageously have a cup shape projecting at opposite ends of the tubular element 58 and defining inner spaces housing the on-board circuit(s) 8. In the case where there are two on-board circuits 8 (only one being visible in FIG. 6), the on-board circuits 8 may be respectively housed in the end elements 60, 62 and insulated from the reservoir or chamber 4 by sealing washers 110, 112. The cylindrical shaped tubular element may also be used with arrangements of prismatic type cells 6 as shown in FIG. 9B. The structure 64 for supporting and spacing the cells 6, the distributor arrangement 66 and the arrangement 70 of electrical connections (as shown in FIG. 6) are then modified accordingly, for example by appropriate elements (not shown) disposed between successive stacks of the cells 6 and at the opposite ends of the tubular element 58. The tubular element 58 may also have a parallelepiped shape as shown in FIG. 9B which may advantageously be suitable for prismatic type cells 6, or another shape such as an oblong shape if desired. Likewise, shapes other than a cup may be used for the end elements 60, 62 if desired. The end elements 60, 62 and the opposite ends of the tubular element 58 may advantageously exhibit flanges 59 for assembly by bolts (not shown) allowing the battery module 2 to be dismantled if necessary. Other kinds of connector and assembly may be used if desired.

Referring to FIGS. 7A and 7B, according to an embodiment, the support and spacing structure 64 comprises elongated bars 72 having outer surfaces substantially matching with an inner surface of the cylindrical element 58 (shown e.g. in FIG. 6), and inner surfaces exhibiting transverse notches 74 distributed in the axial direction of the cylindrical element 58 and in which peripheral edges 76 of the cells 6 engage. The distributor arrangement 66 may comprise conduits 78 extending in the bars 72 and in communication with the fluidic inlet 10 (shown e.g. in FIG. 6), the openings 68 of the distributor arrangement 66 being made in the inner surfaces of the bars 72 so that the heat transfer fluid applies an isostatic (uniform) pressure on the cells 6 immersed in and directly in contact with the heat transfer fluid. The arrangement 70 of electrical connections may be formed by upper and lower series of pads 80, 82 electrically connected to one another and in contact with terminals of the cells 6. The upper series of pads 80 may extend between the bars 72. The above-described configuration of a battery module 2 allows an optimal circulation of the heat transfer fluid (rapid variation of the temperature, uniform temperature of the cells).

Referring again to FIG. 2, the heat transfer fluid circulates between the fluidic unit 14 and the battery modules 2 through a pipe circuit (shown by the thick black lines) provided with devices for flow rate control of the heat transfer fluid, controlled by the controllers 34, 36, 38 in order to adjust a temperature and a pressure of the heat transfer fluid circulating in the pipe circuit. The flow rate control devices may advantageously be, for each battery module 2, a distributor D₁, D₂, D₃ of the heat transfer fluid conveyed to the battery module 2, and a proportional pressure limiter L₁, L₂, L₃ of the heat transfer fluid discharged by the battery module 2.

According to an embodiment, the controller 34(#1) is used as controller for temperature management of the heat transfer fluid in the system in general by controlling flow rate regulating devices formed for example by distributors D₄ and D₅ on the fluidic lines 30, 32 associated to the cooling and heating reservoirs 18, 20 according to the temperature setpoint signal received at the input 40. The controller 34 may have an input 84 for receiving and taking into account a temperature adjustment signal derived from a temperature sensor 35 (T₀) indicative of the temperature of the heat transfer fluid transmitted by the fluidic unit 14. The controller 36 (#2) is used as controller for pressure management of the heat transfer fluid conveyed to and discharged by the battery modules 2 by controlling the distributors D₁, D₂, D₃ and the proportional pressure limiters L₁, L₂, L₃ according to the pressure setpoint signal 44 and the pressure measurement signals (P₁, P₂, P₃) provided by the sensors 33. The controller 36 is thus in charge of controlling the pressure of the heat transfer fluid in the battery modules 2. The controller 36 may have an input 86 for receiving and taking into account a signal derived from a pressure sensor 37 (P_{0′}) indicative of the overall pressure of the heat transfer fluid transmitted by the fluidic unit 14. The controller 38 (#3) is used as controller for temperature management of the heat transfer fluid specifically circulating in the battery modules 2 by controlling the distributors D₁, D₂, D₃ conveying the heat transfer fluid to the battery modules 2 according to the temperature setpoint signal 42 at the level of the cells 6 of the battery modules 2 and the temperature measurement signals (T₁, T₂, T₃) provided by the temperature sensors 31. The controller 38 also provides the temperature setpoint to the controller 34 which manages the fluidic unit 14.

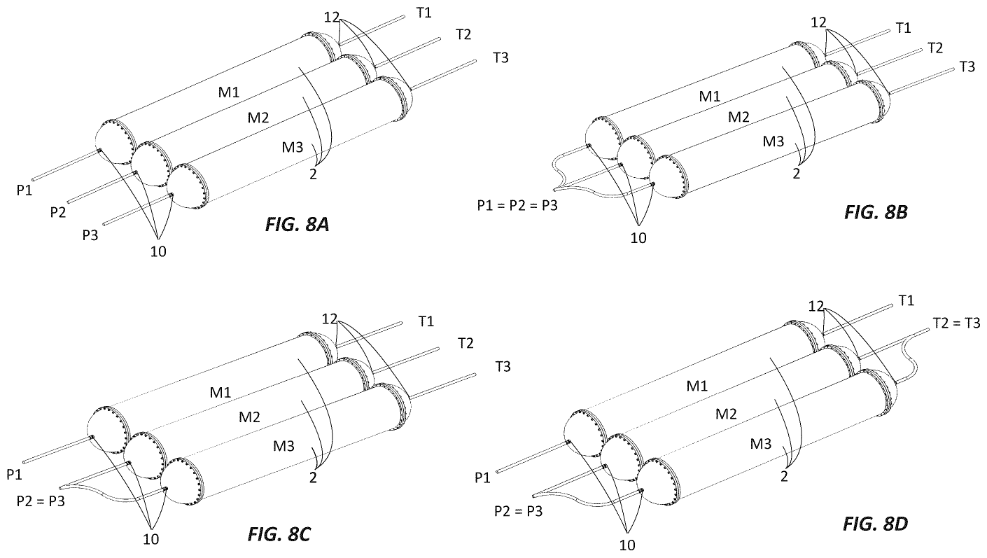

Referring to FIGS. 8A, 8B, 8C and 8D, the battery modules 2 may be arranged so as to form an independent, complementary or combined arrangement depending on whether their fluidic inlets and outlets 10, 12 are combined or separated and according to a chemistry of their cells. For example, each battery module 2 may be independently operated in pressure and in temperature as shown in FIG. 8A. The battery modules 2 may be operated at a common pressure but at different temperatures as shown in FIG. 8B. Some battery modules 2 may be operated at a common pressure different from the pressure of another battery module 2, and at different temperatures for each battery module 2 as shown in FIG. 8C. Some battery modules 2 may be operated at common pressure and temperature different from the operating pressure and temperature of another battery module 2, as shown in FIG. 8D. The design of the battery modules 2 may be chosen as a function of certain operating conditions, for example an extremely rapid recharging, a high acceleration or an important payload to tow in the case of an electric vehicle (not shown), a storage, an extreme outside temperature, and as a function of a use for which they are intended, for example, car, truck, bus, airplane, train, boat, energy storage. As many battery modules 2 as desired may be used, in complementarities or not, with variable capacities and dimensions, combined or not. The values of pressure and temperature of the battery modules 2 may be regulated in real-time or be fixed. One of the battery modules 2 may be intended to play a special role (i.e. its vocation), for example to operate at a fixed pressure and in particular at a very high pressure to handle extreme operating conditions such as an extremely rapid recharging or be called upon in priority during a high acceleration in the case of an electric vehicle, even at the cost of having to replace the battery module 2 after a certain time (e.g. prematurely). Such a battery module 2 may be likened to a sacrifice battery module for increased performance. In one embodiment of the invention, the system may include battery modules 2 whose pressure regulation is carried out solely by variation of the temperature of the heat transfer fluid, in particular if a higher pressure value is necessary for higher temperature values, by using the effect of the thermal expansion coefficient of the heat transfer fluid.

Referring again to FIG. 1, to sum up, according to an embodiment of the invention, the system includes at least one battery module 2 (or several working in collaboration) with variable or fixed operating conditions (variable role or dedicated role), whose active and dynamic management of the operating temperature and pressure applied on the cells 6 (shown e.g. in FIG. 6) is carried out via a liquid (or a fluid) under pressure in which the cells 6 are immersed. The different mechanical, hydraulic, electrical and logical systems described hereinabove are controlled by processors (not shown, but which may be integrated into the BMS 52 or the controllers 34, 36, 38) controlled by scalable and coordinated algorithms via a master software implemented in the BMS 52. The BMS 52 may execute a smart charge management algorithm including an efficient and optimal management strategy for the energy consuming systems (pressure and temperature regulation) during a rapid charging or upon a sudden braking. The scalable algorithms may be based on an artificial intelligence implementation. The active and dynamic management of the operating temperature and pressure applied to the cells 6 allows the optimal usage of the cells of a battery. The cylindrical reservoir formed by the elements 58, 60, 62 (shown e.g. in FIG. 6) of the battery module 2 allows to apply a variable and high isostatic pressure (e.g. up to 2 000 psi) on the cells 6, while being compact and easy to integrate into a vehicle (not shown).

According to an embodiment of the invention, a method for managing operating pressure and temperature of a battery consists in housing cells 6 of the battery in a chamber 4 defined by at least one battery module 2, the chamber having opposite fluidic inlet and outlet 10, 12 for receiving and discharging a heat transfer fluid applied to all the cells 6. The method also involves monitoring a state of charge of the cells 6 in each battery module 2, collecting the heat transfer fluid discharged by the fluidic outlet 12 of each battery module 2 into a return reservoir 16, separately cooling and heating quantities of the heat transfer fluid pumped from the return reservoir 16 into cooling and heating reservoirs 18, 20 at predefined cold and hot temperatures, and conveying the heat transfer fluid to the fluidic inlet 10 of each battery module 2 at temperature and pressure regulated by mixing and flow rate control of the heat transfer fluid derived from the cooling and heating reservoirs 18, 20. The method further involves taking temperature and pressure measurements of the heat transfer fluid conveyed towards and discharged by each battery module 2, controlling the mixing and the flow rate of the heat transfer fluid conveyed to each battery module 2 according to the measurements and temperature and pressure setpoints, and adjusting the temperature and pressure setpoints for the heat transfer fluid and a demand setpoint intended for each battery module 2 as a function of a demand in energy and in power and the state of charge of the cells 6 in each battery module 2. According to an embodiment, the flow rate of the heat transfer fluid conveyed to each battery module 2 is maintained as long as the pressure and temperature measurements are different from the pressure and temperature setpoints. The method may involve executing a scalable process for commanding operating parameters of each battery module 2 as a function of demand, state of charge and state of health conditions of each battery module 2 and as a function of an ambient temperature and a preestablished vocation of a battery module 2 among all the battery modules 2 used.

In the following description, the heat transfer fluid will be considered to be oil. It must however be understood that another appropriate fluid for the invention may be used with a different range of temperatures if desired.

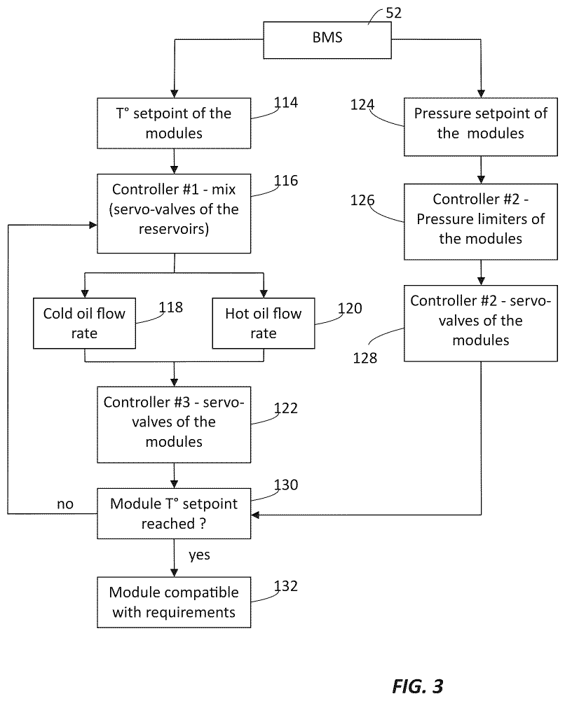

Referring to FIG. 3, according to an embodiment, the temperature setpoint of the oil (mix) 114 is based on the operating temperature setpoint (e.g. from −30° C. to 100° C. or other preferred temperature range) of the cells 6 (shown e.g. in FIG. 6), taking into account thermal losses, thermal inertia, the volume of oil in play, an acceptable time to reach a new operating temperature value and considerations related to the materials (e.g. admissible thermal transitions). The strategy for rapidly reaching the temperature setpoint of the oil may be based on algorithms developed in laboratory for the necessary hot-cold mixing (flow rate) 116, 118, 120, 122. Prioritization by the BMS 52 may be performed on the sequencing for reaching the setpoints if different operating temperatures are required from one battery module 2 to another. A sizing of the components of the system (reservoirs 16, 18, 20, pump 94, accumulator 100, battery module shown e.g. in FIG. 2) is preferably optimized in order to maximize the speed for varying the temperature of the cells 6. Regarding the pressure regulation, the oil may first be brought to the correct temperature, and the pressure setpoint 124 may be simultaneously achieved for all the battery modules 2, even in case of different setpoints from one battery module 2 to another. The controller #2 36 may operate the pressure limiters L₁, L₂, L₃ and the servo-valves D₁, D₂, D₃ of the battery modules 2 (shown e.g. in FIG. 2) to regulate their pressure 126, 128. An interaction of the processes for adjusting the temperature and the pressure of the oil may involve maintaining the flow rate of the oil as long as both setpoints (temperature and pressure) are not reached. The setpoint for reaching the pressure may also take into account the effect of two other factors on the pressure value, namely the oil temperature and the variable volume of the cells (state of charge) 130. A battery module 2 is considered to be compatible with the requirements when the temperature and pressure setpoints are reached 132, otherwise the temperature of the battery module 2 is rectified again 116.

Referring again to FIG. 2, when the BMS 52 (shown e.g. in FIG. 1) sends operating pressure and temperature regulating setpoints to appropriately adjust the usage conditions of the cells 6 (shown e.g. in FIG. 6) as a function of the demand conditions of the latter, limit pressure setpoints are sent to the pressure limiters L₁, L₂, L₃ via the controller #2 36 in order to get the targeted operating pressures P₁, P₂, P₃ in the battery modules 2 (#1, #2 et #3). If the new pressure setpoint for a given battery module 2 is higher than the pressure measured in the battery module 2, the distributor D₁, D₂, or D₃ associated with the battery module 2 (#1, #2 or #3), via the controller 36 (#2), authorizes the oil intake allowing to reach this new pressure value. The new pressure value is instantly reached. The pressure PA in the accumulator 100 allows to produce a pressure P₀ in the cold and hot oil reservoirs 18, 20. When the oil mixing is carried out, a pressure P_{0′} is built upstream of the distributors D₁, D₂, D₃. To enable to instantly build a desired pressure in the battery modules 2, at all times P_{Amin}>P₀>P_{0′}>P₁, P₂, P₃. For example, if the maximum pressure of the modules is set at 1 000 psi, the minimum acceptable pressure in the accumulator 100 could be 1 500 psi. When the value of P_{Amin} will drop under the threshold of 1 500 psi, the pump 94 will start and inject oil into the accumulator 100 until the time where the value of P_{Amax} (for example 2 500 psi) is reached. When an operating temperature setpoint T₁, T₂, T₃ of the cells 6 is sent by the BMS 52, the controller 34 (#1) manages the line distributors of cold and hot oil D₄, D₅ according to flow rate management algorithms in order to generate an oil mix at temperature T₀. To raise the operating temperature value of the cells 6, then T₀>T₁, T₂, T₃. Conversely, to lower the operating temperature value of the cells, then T₀<T₁, T₂, T₃. The difference of values between the temperature of the oil mix T₀ and the operating temperature T₁, T₂, T₃ of the cells 6 depends on the speed for reaching the new operating temperature, taking into account the thermal inertia of the system as a whole and the limits of thermal transition allowed by the materials forming the cells 6. Even if the operating pressure value P₁, P₂, P₃ is reached for a given battery module 2, the controller 38 (#3) allows oil intake at T₀ via the distributor D₁, D₂, D₃ associated with the battery module 2 as long as the target operating temperature T₁, T₂, T₃ of the battery module 2 is not reached.

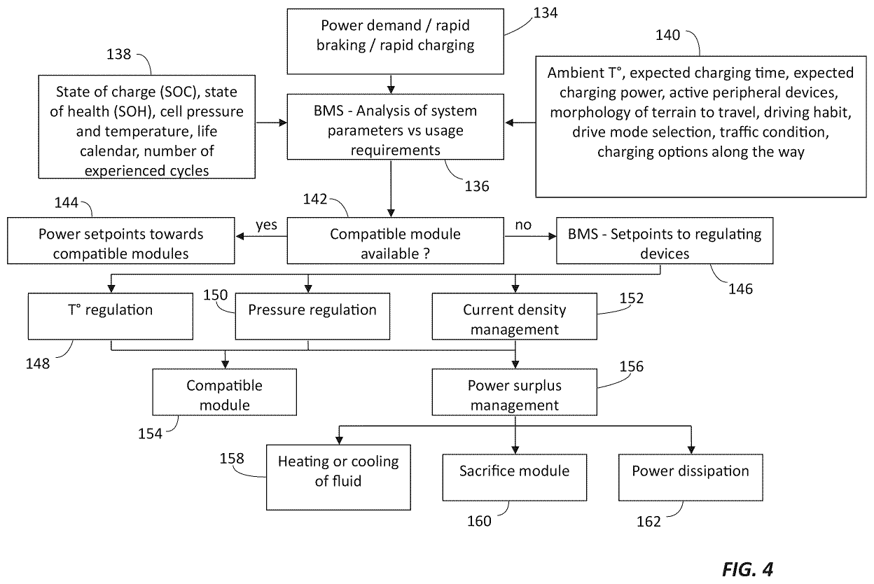

Referring to FIG. 4, there is shown an example of high-level management that the system according to the invention may implement according to different parameters for management of pressure and temperature and operation of a battery module 2. An event 134 such as a power demand, a rapid braking or a rapid charging is signaled to the BMS 52 (shown e.g. in FIG. 1). As depicted by block 136, the BMS 52 performs an analysis of the system parameters versus the usage requirements. For this purpose, the BMS 52 may consider certain conditions such as a state of charge (SOC), a state of health (SOH), pressure and temperature of the cells 6 (shown e.g. in FIG. 6), their life history (calendar) and a number of cycles experienced by the cells 6 of a battery module 2 as depicted by block 138. Likewise, the BMS 52 may consider different parameters such as an ambient temperature, an expected charging time, an expected charging power, active peripheral devices, a morphology of the terrain to travel, a driving habit, a drive mode selection, a traffic condition, charging options along the way, as depicted by block 140. A verification 142 is then carried out to determine if a battery module 2 is compatible with the requirements with respect to the system parameters. If such is the case, power setpoints are transmitted to the compatible battery modules 2, as depicted by block 144. Otherwise, the BMS 52 transmits setpoints to the regulating mechanisms as depicted by block 146. A regulation in temperature 148, a regulation in pressure 150 and a current density management 152 are carried out, so that a battery module 2 is eventually compatible 154. A power surplus management 156 may be carried out for heating or cooling of the oil 158, for using a battery module 2 as a sacrifice module to the detriment of its normal operating parameters 160, or for power dissipation 162 if desired.

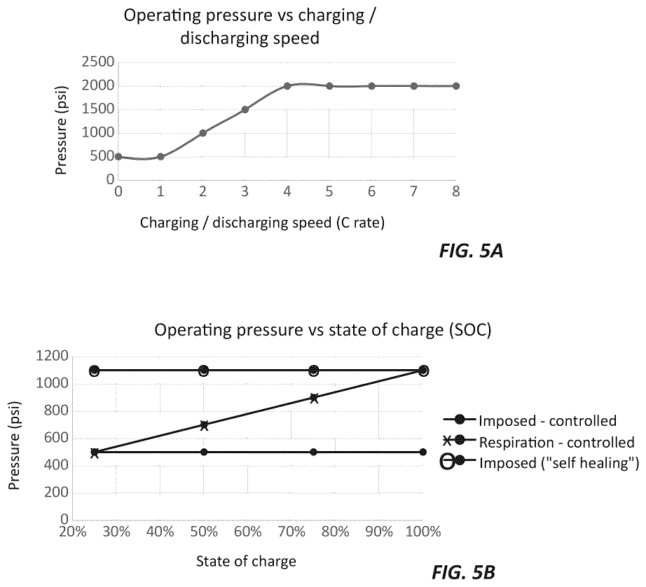

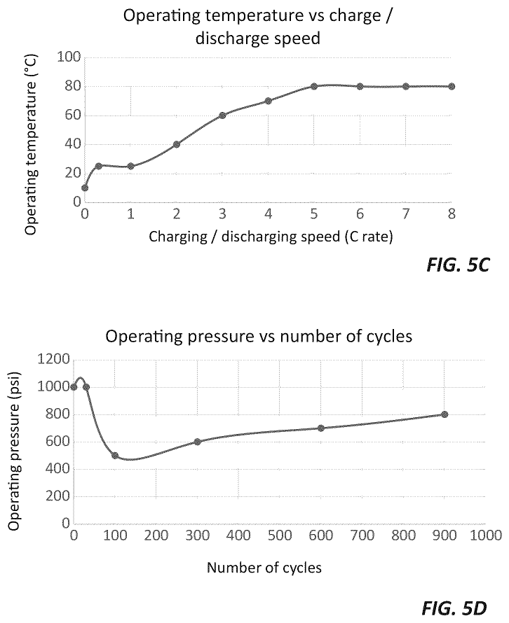

Referring to FIGS. 5A, 5B, 5C and 5D, examples of pressure and temperature management protocols implemented in the system according to an embodiment of the invention are shown in graphical forms. FIG. 5A shows a possible pressure regulating protocol for the cells 6 of a battery module 2 (shown e.g. in FIG. 6) as a function of a recommended charging or discharging speed. FIG. 5B shows a possible pressure regulating protocol for the cells 6 of a battery module 2 as a function of its state of charge (SOC). FIG. 5C shows a possible operating temperature regulating protocol with respect to a recommended charging or discharging speed. FIG. 5D shows a possible operating pressure regulating protocol with respect to a number of charge and discharge cycles experienced by a battery module 2.

Referring again to FIG. 1, certain considerations relating to the system according to the invention may be relevant. For example, the value of the oil pressure in a pressurized reservoir will tend to vary as a function of the following factors: the pressure setpoint imposed to the fluidic unit 14 by the BMS 52, the variation of the oil temperature, the volume variation of the cells 6. The pressure regulation control algorithm may include coordinated inputs related to these factors, based on a model integrating an interaction of the pressure and temperature setpoints, as well as a feedback on the state of charge of the cells 6, thus their volume at a specific time. The BMS 52 may coordinate and direct a use of the different battery modules 2 as a function of a demand in energy and in power. A proximity management of each of the battery modules 2 may be carried out on board each battery module 2 by an on-board BMS or a BMS—module implemented by the on-board circuits 8. A monitoring of oil, involving for example a monitoring of chemical elements or dissolved gas, may allow identifying symptoms of deterioration of the components forming a battery module 2. A mineral oil used as heat transfer fluid may allow neutralizing potential chemical reactions in the event of a defective or damaged cell 6. An implementation of scalable algorithms, e.g. artificial intelligence in the BMS 52 may represent a strategic aspect of the use of the system according to the invention. Such algorithms may be in charge of managing the operating parameters of the battery modules 2 (current, pressure, temperature). A programming (e.g. in factory) of the initial algorithms in the BMS 52 may be made as a function of the use of the battery modules 2 (e.g. car, bus, truck, airplane, boat, storage, etc.). A modification of such algorithms may occur over time, depending on different factors such as a type of driving (e.g. acceleration, braking, load towing), a terrain morphology, outside temperatures, charging patterns, usage patterns (frequency, duration). Scalable algorithms may lead to a decision of overusing a battery module 2 in case of extreme usage conditions (e.g. sacrifice module). They may also lead to a particular charging scheme (as a function of the electricity demand/billing rate, the decline in performances of the battery modules 2, a suspected presence of a dendrite initiation zone), including a repair procedure of dendritic damages (“self-healing”) by strategically combining temperature-pressure-current values and charging current patterns known for their beneficial effects on the state of the battery.

While embodiments of the invention have been illustrated in the accompanying drawings and described above, it will be evident to those skilled in the art that modifications may be made therein without departing from the invention.

1. A system for managing operating pressure and temperature of a battery, the system comprising:
at least one battery module having a chamber housing cells of the battery, and at least one on-board circuit connected to the cells and configured to control their operation and monitor their state of charge, the chamber having opposite fluidic inlet and outlet for receiving and discharging a heat transfer fluid applied to all the cells;
a fluidic unit having a return reservoir in communication with the fluidic outlet of each battery module, a cooling reservoir for containing a quantity of the heat transfer fluid pumped from the return reservoir at a predefined cold temperature, a heating reservoir for containing a quantity of the heat transfer fluid pumped from the return reservoir at a predefined hot temperature, and a temperature and pressure regulating device having inlets in communication with the cooling and heating reservoirs and at least one outlet in communication with the fluidic inlet of each battery module in order to transmit the heat transfer fluid at a temperature and a pressure by controlled mixing and flow rate of the heat transfer fluid derived from the cooling and heating reservoirs;
temperature and pressure sensors for measuring temperature and pressure of the heat transfer fluid circulating between the fluidic unit and said at least one battery module;
at least one controller having inputs for receiving temperature and pressure setpoint signals for the heat transfer fluid in said at least one battery module, inputs for receiving temperature and pressure measurement signals produced by the temperature and pressure sensors, and outputs for producing signals controlling the mixing and the flow rate of the heat transfer fluid transmitted by the fluidic unit according to the setpoint signals and the temperature and pressure measurement signals; and
a BMS connected to said at least one controller and to said at least one on-board circuit, the BMS being configured to produce the temperature and pressure setpoint signals for the heat transfer fluid and a demand setpoint intended for said at least one battery module as a function of a demand in energy and in power received in input and the state of charge provided by said at least one on-board circuit.

2. The system according to claim 1, wherein the cells of said at least one battery module are immersed in and directly in contact with the heat transfer fluid which applies an isostatic pressure on the cells.

3. The system according to claim 1, wherein the heat transfer fluid is oil.

4. The system according to claim 1, wherein said at least one battery module comprises:
a tubular element and end elements closing the tubular element to define the chamber;
a structure supporting and spacing the cells in an axial direction of the tubular element;
a distributing arrangement of the heat transfer fluid in communication with the fluidic inlet and having openings aligned with spaces between the cells; and
an arrangement of electrical connections connecting the cells and said at least one on-board circuit together.

5. The system according to claim 4, wherein the end elements have a cup shape projecting from opposite ends of the tubular element and defining inner spaces housing said at least one on-board circuit.

6. The system according to claim 4, wherein:
the structure supporting and spacing the cells comprises elongated bars having outer surfaces substantially matching with an inner surface of the tubular cylindrical element, and inner surfaces exhibiting transverse notches distributed in the axial direction of the cylindrical tubular element and in which peripheral edges of the cells engage;
the distributing arrangement comprises conduits extending in the bars and in communication with the fluidic inlet, the openings of the distributing arrangement being made in the inner surfaces of the bars so that the heat transfer fluid exert an isostatic pressure on the cells; and
the arrangement of electrical connections comprises upper and lower series of pads electrically connected to one another and in contact with terminals of the cells, the upper series of pads extending between the bars, said at least one on-board circuit comprising two on-board circuits housed in the end elements.

7. The system according to claim 1, wherein the heat transfer fluid circulates between the fluidic inlet and said at least one battery module through a pipe circuit provided with devices for regulating a flow rate of the heat transfer fluid, controlled by said at least one controller in order to adjust a temperature and a pressure of the heat transfer fluid circulating in the pipe circuit.

8. The system according to claim 7, wherein the devices for regulating the flow rate comprise, for each battery module, a distributor of the heat transfer fluid conveyed to the battery module, and a proportional pressure limiter of the heat transfer fluid discharged by the battery module.

9. The system according to claim 1, wherein said at least one controller comprises:
a first controller for temperature management of the heat transfer fluid, controlling flow rate regulating devices on fluidic lines associated with the cooling and heating reservoirs according to a temperature setpoint;
a second controller for pressure management of the heat transfer fluid circulating in said at least one battery module, controlling flow rate regulating devices of the heat transfer fluid conveyed to and discharged by said at least one battery module according to the pressure setpoint signal and the pressure measurement signal; and
a third controller for temperature management of the heat transfer fluid circulating in said at least one battery module, controlling the flow rate regulating device of the heat transfer fluid conveyed to said at least one battery module according to the temperature setpoint signal and the temperature measurement signal.

10. The system according to claim 1, wherein said at least one battery module comprises several battery modules forming an independent, complementary or combined arrangement depending on whether their fluidic inlets and outlets are combined or separated and depending on a chemistry of their cells.

11. The system according to claim 1, wherein the BMS is configured to store and execute a scalable algorithm for commanding operating parameters of said at least one battery module as a function of demand, state of charge and state of health conditions of said at least one battery module and as a function of an ambient temperature and a preestablished vocation of one battery module among said at least one battery module.

12. The system according to claim 11, wherein:
the operating parameters comprise the pressure and the temperature of the heat transfer fluid circulating in said at least one battery module and a power admitted by said at least one battery module; and
the demand conditions comprise a rapid charging and a power demand.

13. The system according to claim 1, further comprising a heat exchanger associated with the reservoirs of the fluidic unit and peripheral devices generating thermal energy.

14. The system according to claim 1, wherein the predefined hot temperature is from 80° C. to 100° C. and the predefined cold temperature is from −30° C. to 0° C.

15. The system according to claim 1, wherein the fluidic unit comprises:
a pump having an inlet communicating with the return reservoir and an outlet for transmitting a quantity of the heat transfer fluid pumped from the return reservoir; and
an accumulator having an inlet communicating with the outlet of the pump and an outlet communicating with the cooling and heating reservoirs, the accumulator producing a control signal controlling the pump according to a pressure measurement provided by a pressure sensor at the outlet of the accumulator so that a pressure of the heat transfer fluid in the cooling and heating reservoirs is slightly higher than the pressure setpoint.

16. A method for managing operating pressure and temperature of a battery, the method comprising the steps of:
housing cells of the battery in a chamber defined by at least one battery module, the chamber having opposite fluidic inlet and outlet for receiving and discharging a heat transfer fluid applied to all the cells;
monitoring a state of charge of the cells in said at least one battery module;
collecting the heat transfer fluid discharged by the fluidic outlet of each battery module into a return reservoir;
separately cooling and heating quantities of the heat transfer fluid pumped from the return reservoir into the cooling and heating reservoirs at predefined cold and hot temperatures;
conveying the heat transfer fluid to the fluidic inlet of said at least one battery module at temperature and pressure regulated by mixing and flow rate control of the heat transfer fluid derived from the cooling and heating reservoirs;
taking temperature and pressure measurements of the heat transfer fluid conveyed towards and discharged by said at least one battery module;
controlling the mixing and the flow rate of the heat transfer fluid conveyed to said at least one battery module according to the measurements and temperature and pressure setpoints; and
adjusting the temperature and pressure setpoints of the heat transfer fluid and a demand setpoint intended for said at least one battery module as a function of a demand in energy and in power and the state of charge of the cells in said at least one battery module.

17. The method according to claim 16, wherein the flow rate of the heat transfer fluid conveyed to said at least one battery module is maintained as long as the pressure and temperature measurements are different from the pressure and temperature setpoints.

18. The method according to claim 16, further comprising the step of executing a scalable process for commanding operating parameters of said at least one battery module as a function of demand, state of charge and state of health conditions of said at least one battery module and as a function of an ambient temperature and a preestablished vocation of one battery module among said at least one battery module.

19. The method according to claim 16, wherein the cells of said at least one battery module are immersed in and directly in contact with the heat transfer fluid which applies an isostatic pressure on the cells.
